(19) United States
(12) Patent Application Publication
(10) Pub. No.: US 2005/0042515 A1
(43) Pub. Date: Feb. 24, 2005

(54) Composition for protecting negative electrode for lithium metal battery, and lithium metal battery fabricated using same

(76) Inventors: Duck-Chul Hwang, Suwon-si (KR); Seung-Sik Hwang, Suwon-si (KR); Chung-Kun Cho, Suwon-si (KR); Sang-Mock Lee, Suwon-si (KR)

Correspondence Address: CHRISTIE, PARKER & HALE, LLP, PO BOX 7068, PASADENA, CA, 91109-7068, US

(21) Appl. No.: 10/923,126

(22) Filed: Aug. 19, 2004

(30) Foreign Application Priority Data
Aug. 20, 2003 (KR) 2003-0057689

(51) Int. Cl. H01M 4/58; H01M 4/62; H01M 4/48

(52) U.S. Cl. 429/231.95; 252/182.1; 429/217; 429/231.1

(57) ABSTRACT

Disclosed is a composition for protecting a negative electrode for a lithium metal battery including a multifunctional monomer having at least two double bonds for facilitating cross-linking, a plasticizer, and at least one alkali metal salt.

### CROSS-REFERENCE TO RELATED APPLICATION

This application is based on application No. 2003-57689 filed in the Korean Intellectual Property Office on Aug. 20, 2003, the disclosure of which is incorporated herein by reference.

### FIELD OF THE INVENTION

The present invention relates to a composition for protecting a negative electrode for a lithium metal battery, and a lithium metal battery fabricated using the same and, more particularly, to a composition for protecting a negative electrode for a lithium metal battery which can provide good battery cycle life characteristics, and a lithium metal battery fabricated using the same.

### BACKGROUND OF THE INVENTION

The continued development of portable electronic devices has led to a corresponding increase in the demand for rechargeable batteries having both a lighter weight and a higher capacity. To satisfy such demands, the most promising approaches include rechargeable lithium batteries.

Among these rechargeable lithium batteries, lithium metal batteries have become very attractive because they have a high capacity. Lithium metal batteries are batteries with a lithium metal negative electrode, and include lithium ion batteries and lithium sulfur batteries. Lithium has a low density of 0.54/cm³ and a very low standard reduction potential of −3.045V SHE (Standard Hydrogen Electrode), and such properties make active lithium materials having a high energy density particularly attractive.

However, the high reactivity of lithium metal causes the formation of dendrites derived from the reaction between lithium and electrolyte during charge and discharge, so battery cycle life characteristics deteriorate. Thus, there is a need in lithium metal batteries for lithium metal having reduced reactivity.

### SUMMARY OF THE INVENTION

It is an aspect of the present invention to provide a composition for protecting a negative electrode for a lithium metal battery which can prevent the side reaction between the negative electrode and an electrolyte, improving the battery's cycle life.

It is another aspect to provide a lithium metal battery fabricated using the composition.

These and other aspects may be achieved by a composition for protecting a negative electrode for a lithium metal battery, which composition includes a multifunctional monomer having at least two double bonds for facilitating cross-linking, a plasticizer having an ether group; and at least one alkaline metal salt.

In order to achieve these aspects and others, the present invention further provides a lithium metal battery including a positive electrode, a negative electrode, and an electrolyte. The positive electrode includes a positive active material. The negative electrode includes a negative active material and has a protection layer on a surface thereof. The protection layer includes a multifunctional monomer having at least two double bonds being capable of cross-linking, and a plasticizer having an ether group and at least one alkaline metal salt.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a schematic diagram illustrating a lithium metal battery;

FIG. 2 is a drawing illustrating a negative electrode shown in FIG. 1;

FIG. 3 is a FT-IR analysis graph of a composition and a cross-linked layer for protecting a negative electrode according to Example 9 of the present invention;

FIG. 4 is a pyrolysis-gas chromatograph of the cross-linked layer for protecting a negative electrode according to Example 9 of the present invention; and

FIG. 5 is a graph showing the cycle life characteristic of lithium sulfur batteries according to Example 27 of the present invention and Comparative Examples 4 and 5.

### DETAILED DESCRIPTION OF THE INVENTION

The present invention relates to a composition for protecting a negative electrode. The composition forms a protective layer on the negative electrode so that the layer prevents the reaction between the negative electrode and an electrolyte, thereby improving the cycle life characteristics.

The composition includes a multifunctional monomer having at least two double bonds for facilitating cross-linking, a plasticizer having an ether group, and at least one alkali metal salt.

The multifunctional monomer may be an allylic compound, an acrylate-based compound, or an acryloyl-based compound, including at least two functional groups. The multifunctional monomer preferably has an average number molecular weight of 170 to 4,000.

Non-limiting examples of allylic compounds include diallyl maleate, diallyl sebacate, diallyl phthalate, triallyl cyanurate, triallyl isocyanurate, triallyl trimellitate, or triallyl trimesate.

Non-limiting examples of the acrylate-based compound include ethylene glycol di(meth)acrylate (EGD(M)A), diethylene glycol di(meth)acrylate ([DEGD(M)A], triethylene glycol di(meth)acrylate (TriEGD(M)A), tetraethylene glycol di(meth) acrylate(TetEGD(M)A), polyethylene glycol di(meth) acrylate (PEGD(M)A), tripropylene glycol di(meth)acrylate (TriPGD(M)A), tetrapropylene glycol di(meth) acrylate (TetPGD(M)A), nonapropylene glycol di(meth)acrylate (NPGD(M)A), polypropylene glycol di(meth)acrylate (PPGD(M)A), 1,3-butylene glycol di(meth)acrylate, 1,4-butanediol di(meth)acrylate, 1,5-pentadiol di(meth)acrylate, neopentyl glycol di(meth)acrylate, diacrylate of caprolactone-modified neopentyl glycol hydroxypivalate ester, 1,6-hexanediol di(meth)acrylate, 1,6-hexanediol ethoxylate di(meth)acrylate, 1,6-hexanediol propylate di(meth)acrylate, trimethylolpropane tri(meth)acrylate, trimethylolpropane ethoxylate tri(meth)acrylate, trimethylolpropane benzoate di(meth)acrylate, propylene oxide-modified trimethylol propane tri(meth)acrylate, di(trimethylolpropane) tetra(meth)acrylate, pentaerythritol tri(meth)acrylate, pentaerythritol tetra(meth)acrylate, pentaerythritol propylate tri(meth)acrylate, dipentaerythritol penta-/hexa(meth)acrylate, alkyloyl-partially-modified dipentaerythritol acrylate, hexa(meth)acrylate of dipentaerythritol-partially-modified caprolactone, bisphenol A di(meth)acrylate, bisphenol A ethoxylate di(meth)acrylate, diacrylate of bisphenol F partially-modified ethylene oxide, 3-hydroxy-2,2-dimethylpropyl-3-hydroxy-2,2-dimethylpropionate di(meth)acrylate, 1,14-tetradecanediol di(meth)acrylate, tricyclic(5.2.1.0(2,6))decanedimethanol di(meth)acrylate, and S,S′-thiodi-4,1-phenylene bis(thiomethacrylate).

Non-limiting examples of acryloyl-based compounds include at least one compound selected from the group consisting of poly(acrylonitrile-co-butadiene-co-acrylic acid), dicarboxy-terminated, glycidyl methacrylate diester; bis(2-methacryloyloxy)ethyl phosphate, trismethacryloyloxyethyl phosphate; bismethacryloyloxyethyl hydroxyethyl isocyanurate; tri(2-acryloyloxy)ethyl isocyanurate, trismethacryloyloxyethyl isocyanurate; hydroxypivayl hydroxylpivalate bis(6-(acryloyloxy)hexanoate); and 1,3,5-triacryloylhexahydroxy-1,3,5-triazine. In the above compound names, the prefix “(meth)” and the abbreviation: (M) simultaneously indicates compounds with a methyl group and compounds without a methyl group. For example, ethylene glycol di(meth)acrylate (EGD(M)A) indicates ethylene glycol dimethacrylate (EGDMA) and ethylene glycol diacrylate (EGDA).

A more preferred multifunctional monomer is polyethyleneglycol dimethacrylate, and a most preferred multifunctional monomer is polyethyleneglycol dimethacrylate having a number-average molecular weight of from 250 to 1,100.

The amount of the multifunctional monomer is preferably 5 to 50 parts by weight, and more preferably 10 to 35 parts by weight, based on 100 parts by weight of the total composition. When the amount of the multifunctional monomer is less than 5 parts by weight, the degree of cross-linking is reduced so that the resulting thin film is not dense. However, an amount larger than 50 parts by weight excessively increases the degree of cross-linking, and the resulting thin film is too dense, thereby decreasing ionic conductivity and producing a brittle thin film.

The composition of the present invention further may include a reactive monomer having an alkylene oxide group and a reactive double bond. A preferred example of the reactive monomer is one represented by formula 1. 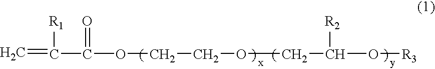
where, R₁ and R₂ are all the same or all different and independently selected from H or a C₁ to C₆ alkyl; R₃ is H, a C₁ to C₁₂ alkyl, or a C₆ to C₃₆ aryl; R₁ to R₃ are all the same or all different; one of R₁ to R₃ is different from the remaining two of R₁ to R₃; and
x≧1, y≧0, or x≧0, y≧1.

The reactive monomer has a number-average molecular weight of from 130 to 1,100.

Non-limiting examples of the reactive monomer of formula 1 include one or a mixture of ethylene glycol methyl ether (meth)acrylate (EGME(M)A), ethylene glycol phenylether (meth)acrylate (EGPE(M)A), ethylene glycol phenylether (meth)acrylate (EGPE(M)A), diethylene glycol methyl ether (meth)acrylate (DEGME(M)A), diethylene glycol 2-ethylhexylether (meth)acrylate(DEGEHE(M)A), polyethylene glycol methylether (meth)acrylate (PEGME(M)A), polyethylene glycol ethylether (meth)acrylate (PEGEE(M)A), polyethylene glycol 4-nonylphenylether (meth) acrylate (PEGNPE(M)A), polyethylene glycol phenylether (meth)acrylate (PEGPE(M)A), ethylene glycol dicyclophenylether (meth) acrylate (EGDCPE(M)A), polypropylene glycol methylether (meth)acrylate (PPGME(M)A), polypropylene glycol 4-nonylphenylether (meth) acrylate, or dipropylene glycol allylether (meth)acrylate.

The preferred reactive monomer is polyethyleneglycol methylether methacrylate, and most preferred is polyethyleneglycol methylether methacrylate having a number-average molecular weight of 300 to 500.

It is preferable to include both the multifunctional monomer and the reactive monomer in the composition of the present invention because this produces maximum effect. That is, when the reactive monomer is present together with the multifunctional monomer, the density of the cross-linking can be desirably controlled, thereby improving mobility of ions and the opened side chain of the alkylene end. Using only a reactive monomer cannot facilitate formation of a three-dimensional network structure so that the inventive effect is not realized.

The amount of the reactive monomer is preferably 5 to 90 parts by weight, based on 100 parts by weight of the total composition, and more preferably 15 to 50 parts by weight. When the amount of the reactive monomer is less than 5 parts by weight, the adhesion between the negative electrode and the resulting protective layer decreases, and the ductility of the resulting protective layer also decreases. If the amount of the reactive monomer is larger than 90 parts by weight, it is difficult to form a network structure thin film layer.

The plasticizer is a compound having an ether group, and preferably is a C₄ to C₃₀ alkylene glycol dialkyl ether or a C₃ to C₄ cyclic ether. Non-limiting examples of alkylene glycol ethers include dimethoxyethane (DME), bis(2-methoxyethylether) (DGM), triethylene glycol dimethylether (TriGM), tetraethylene glycol dimethylether (TetGM), polyethylene glycol dimethylether (PEGDME), and propylene glycol dimethylether (PGDME). A non-limiting example of the cyclic ether is dioxolane. The plasticizer uses one or a mixture thereof of such compounds.

The amount of the plasticizer is preferably 5 to 70 parts by weight, based on 100 parts by weight of the total composition, and more preferably 20 to 50 parts by weight. An amount smaller than 5 parts by weight decreases the ability to dissociate lithium ions, and a reduction in ionic conductivity, while an amount larger than 70 parts by weight deteriorates mechanical properties of the protective layer.

The alkali metal salt may be a compound represented by formula 2,
AB (2)
where A is an alkali metal cation selected from the group consisting of lithium, sodium, and potassium, and B is an anion.

Non-limiting examples of the alkali metal salt include one or a mixture of LiClO₄, LiBF₄, LiPF₆, LiAsF₆, LiAlCl₄, LiSbF₆, LiSCN, LiCF₃SO₃, LiN(CF₃SO₂)₂, LiN(C₂F₅SO₂)₂, LiC₄F₉SO₃, LiCF₃CO₂, LiN(CF₃CO₂)₃, NaClO₄, NaBF₄, NaSCN, or KBF₄.

The amount of the alkali metal salt is preferably 3 to 20 parts by weight, based on 100 parts by weight of the total composition, and more preferably 5 to 20 parts by weight. An amount smaller than 3 parts by weight causes a reduction in the number of ions and decreased ionic conductivity, while an amount larger than 20 parts by weight leads to crystallization and decreased ionic conductivity.

The composition of the present invention further may include a photoinitiator or a thermal initiator such as peroxides (—O—O—) or azo-based compounds (—N═N—). Non-limiting examples of photoinitiators include benzoin, benzoinethylether, benzoinisobutylether, alphamethylbenzoinethylether, benzoin phenylether, acetophenone, dimethoxyphenylacetophenone, 2,2-diethoxyacetophenone, 1,1-dichloroacetophenone, trichloroacetophenone, benzophenone, p-chlorobenzophenone, 2,4-dihydroxybenzophenone, 2-hydroxy-4-methoxybenzophenone, 2-hydroxy-2-methyl propionphenone, benzyl benzoate, benzoyl benzoate, anthraquinone, 2-ethylanthraquinone, 2-chloroanthraquinone, 2-methyl-1-(4-methylthiophenyl)-morpolynopropaneone-1,2-hydroxy-2-methyl-1-phenylpropane-1-one (available from Ciba Geigy, Darocure 1173), a series of Darocur® from Ciba Geigy, 2-benzyl-2-dimethylamino-1-(4-morpolynophenyl)-butanone-1,1-hydroxycyclohexylphenylketone (available from Clba Geigy, Irgacure 184), a series of Irgacure® from Ciba Geigy, benzyldimethylketal, thioxanthone, isopropyl thioxanthone, chlorothioxanthone, benzyl disulfide, butanedione, carbazole, fluorenone, and alphaacyloxime ester.

Non-limiting examples of thermal initiators include peroxides (—O—O—), such as benzoyl peroxide, acetyl peroxide, dilauryl peroxide, di-tert-butyl peroxide, and cumyl hydroperoxide; and azo (—N═N—)-based compounds, such as azobisbutyronitrile and azobisisovaleronitrile.

The amount of the photoinitiator or thermal initiator is preferably 0.05 to 5 parts by weight, and more preferably 0.1 to 1 part by weight, based on 100 parts by weight of the total composition. If the amount of the photoinitiator is less than 0.05 parts by weight, the time required for the photo-curing (hardening) step becomes unduly long. Also, if the amount of the photoinitiator is more than 5 parts by weight, no additional benefit is realized.

The protective layer of the present invention is formed by coating the composition on a negative electrode and curing it. The coating process is performed by any technique that uniformly forms a film on a surface of the negative electrode. The coating process is performed, for example, using a gravure coater, a reverse roll coater, a slit die coater, a screen coater, a spin coater, a cap coater which uses a capillary phenomenon, a doctor blade, or a deposition device for polymer thin film formation. Thereafter, the coating on the electrode is cured by irradiating it with ultraviolet rays, electron rays, X-rays, gamma rays, microwaves, or a high frequency discharge, or by heating it to form a thin layer. The curing process is believed to cause polymerization of the monomers and cross-linking of the resulting polymers, and hardens the coating. In the present invention, the coating processes and hardening processes are presented by way of example, and are not intended to limit the invention.

The protective layer has a thickness of 0.1 to 50 μm, and preferably 0.3 to 30 μm. A thinner protective layer of less than 0.1 μm cannot sufficiently protect the negative electrode because of reduced strength, whereas a protective layer having a thickness greater than 50 μm causes a relatively increase in the volume of the negative electrode, resulting in reduced battery capacity.

According to one aspect of the invention, a negative electrode 12 with the protective layer 12b on both surfaces 12a of the lithium metal or alloy of lithium metal is shown in FIG. 2. In addition, the protective layer may be formed on one surface of the lithium metal.

Non-limiting examples of alloying metals for lithium metal include Al, Mg, K, Na, Ca, Sr, Ba, Si, Ge, Sb, Pb, In or Zn.

Furthermore, the negative electrode may include an inorganic single or double protective layer. If the negative electrode additionally includes an inorganic protective layer, the inorganic protective layer may be present on the protective layer of the present invention, or between the inventive protective layer and the lithium metal or alloy. Alternatively, the negative electrode may be present in the form of a structure consisting of the lithium metal or alloy/inventive protective layer/inorganic protective layer/inventive protective layer, or a structure consisting of lithium metal or alloy/inorganic protective layer/inventive protective layer/inorganic protective layer. Non-limiting examples of the inorganic protective layer include LiPON, Li₂CO₃, Li₃N, Li₃PO₄, and Li₅PO₄. Alternatively, the inorganic protective layer may include lithium nitride, lithium carbonate, lithium silicate, lithium borate, lithium aluminate, lithium phosphate, lithium phosphorus oxynitride, lithium silicosulfide, lithium germanosulfide, lithium lanthanum oxide, lithium titanium oxide, lithium borosulfide, lithium aluminosulfide, lithium phosphosulfide, or a mixture thereof. The inorganic protective layer preferably has a thickness of 10 Å to 10,000 Å.

The protective layer has good compatibility, facilitates dissociation of the alkali metal salt, and has good adhesion to the negative electrode. In addition, the protective layer prevents the side reaction between the negative electrode and the electrolyte, and forms a stable SEI (solid electrolyte interface) layer on a surface of the negative electrode, which represses loss of lithium metal and formation of dendrites, resulting in improvement in the battery's cycle life. The protective layer has ionic conductivity of approximately 2×10⁻² S/cm at room temperature, and good adhesion to lithium metal and mechanical properties.

Generally, the high reactivity of lithium metal as a negative electrode causes a continued side reaction with an electrolyte, or lithium sulfide or lithium polysulfide to be produced during charge and discharge, thereby causing an abrupt loss of lithium and the continued formation of lithium dendrite. This results in a deterioration of battery cycle life.

The composition for protecting the negative electrode of the present invention can solve such problems, improving the battery's cycle life.

As described above, the present invention uses acrylate-based compounds in the battery, which have been conventionally studied. For example, U.S. Pat. No. 5,648,011 discloses a gelled electrolyte including a crosslinker such as triacrylate, a solvent gelling agent such as silica, a non-aqueous solvent, and a lithium salt. However, in the '011 patent, the acrylate-based compound is used in the gel electrolyte, whereas, in the present invention, the acrylate-based compound is used to form a protective layer for the negative electrode. In addition, in the '011 patent, in order to increase ionic conductivity the non-aqueous solvent is used in a large amount, rather than using a monomer with alkylene oxide as in the present invention. The use of excess solvent as described in the '011 patent causes a decrease in mechanical properties such as elasticity and adhesion.

According to another aspect the present invention, a lithium metal battery has a negative electrode coated with a protective layer, and a positive electrode. The positive electrode includes a positive active material in which a redox reaction reversibly occurs. The positive active material includes a lithium transition metal oxide which is capable of intercalating and deintercalating lithium ions, examples of which are well known in the related art. Alternatively, the positive active material includes elemental sulfur (S₈), Li₂Sₙ (n≧1), Li₂Sₙ (n≧1) dissolved in catholyte, organic-sulfur compounds, or a carbon-sulfur polymer ((C₂Sₓ)ₙ: x=2.5 to 50, n≧2).

The lithium metal battery includes an electrolyte having a lithium salt and an organic solvent, and may include a separator which prevents a short circuit and is located between the negative electrode and the positive electrode. As the electrolyte and the separator, any convention materials can be used as long as they are appropriate for their intended function.

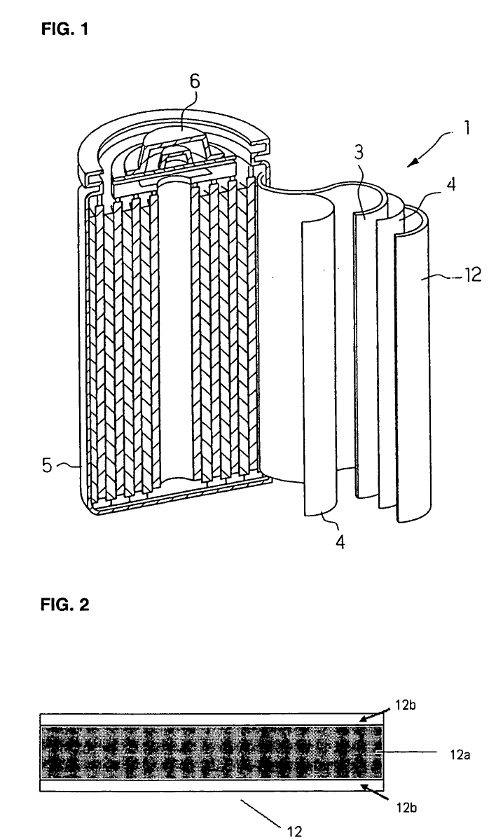

An embodiment of a lithium metal battery according to the present invention is illustrated in FIG. 1. As shown, the lithium metal battery includes a positive electrode 3; a negative electrode 12 with a cross-linkable protective layer; a separator 4 interposed between the positive electrode 3 and the negative electrode 2; an electrolyte in which the positive electrode 2, the negative electrode 3, and the separator 4 are immersed; a cylindrical battery case 5; and a sealing portion 6. The negative electrode 12 is illustrated in more detail in FIG. 2. The negative electrode 12 includes the cross-linked protective layer 12b on both surfaces of the negative active material 12a. The configuration of the rechargeable lithium battery is not limited to the structure shown in FIG. 1, as it can be readily modified into a prismatic or pouch type battery, as is well understood in the related art.

The following examples illustrate the present invention in further detail, but it is understood that the present invention is not limited by these examples.

### EXAMPLE 1

9 g of a diethylene glycol diacrylate multifunctional monomer, 5 g of a polyethylene glycol methylether methacrylate (molecular weight: 300) reactive monomer, 6 g of a polyethylene glycol dimethylether (molecular weight: 250) plasticizer, 2.06 g of a LiCF₃SO₃ lithium salt, and 0.065 g of a benzoinethylether photoinitiator were mixed to completely dissolve the lithium salt and the photoinitiator, thereby obtaining a composition for protecting a negative electrode.

The composition was coated on a glass substrate with a predetermined thickness. A spacer for controlling thickness was then settled on each end of the substrate and another glass substrate was covered thereon, in order to obtain a film with a uniform thickness. Thereafter, the substrate was irradiated with ultraviolet light (365 nm wavelength) for 2 minutes, which cured and hardened the coating, yielding a 20 μm thick transparent protective layer.

The protective layer was located between stainless steel plates, and its alternating-current impedance was measured. The resulting value, complex impedance, was analyzed using a frequency response analyzer, thereby measuring ionic conductivity. The ionic conductivity of the cross-linked protective layer was 6.2×10⁻⁷ S/cm at room temperature. The obtained protective layer had hard and brittle properties.

### EXAMPLE 2

5.4 g of a diethylene glycol diacrylate multifunctional monomer, 5.4 g of a polyethylene glycol methylether methacrylate (molecular weight 300) reactive monomer, 9.2 g of a polyethylene glycol dimethyl ether (molecular weight 250) plasticizer, 5.76 g of a LiN(CF₃SO₂)₂ lithium salt, and 0.048 g of a benzoinethyl ether photoinitiator were mixed to completely dissolve the lithium salt and the photo initiator, thereby obtaining a composition for protecting a negative electrode.

Using the composition, a cross-linked protective layer was produced according to the same procedure as in Example 1, and its ionic conductivity was measured. The measured ionic conductivity was 4.7×10⁻⁶ S/cm. The obtained protective layer was transparent and exhibited good adhesion, ductility, and mechanical strength.

### EXAMPLE 3

4 g of a diethylene glycol diacrylate multifunctional monomer, 4 g of a polyethylene glycol methylether methacrylate (molecular weight 300) reactive monomer, 12 g of a polyethylene glycol dimethylether (molecular weight 2500 plasticizer, 6.12 g of a LiN(CF₃SO₂)₂ lithium salt, and 0.038 g of a benzoinethylether photoinitiator were mixed to completely dissolve the lithium salt and the photoinitiator, thereby obtaining a composition for protecting a negative electrode.

Using the composition, a cross-linked protective layer was produced according to the same procedure as in Example 1 and the ionic conductivity was measured. The measured ionic conductivity was 2.7×10⁻⁴ S/cm. The obtained protective layer was transparent and exhibited good adhesion and ductility, but slightly weak mechanical strength.

### EXAMPLE 4

A composition for protecting a negative electrode was prepared by the same procedure as in Example 3, except that 1 g of an azobisisobutyronitrile thermoinitiator was used.

The composition was coated on a glass substrate having a predetermined thickness, and spacers for controlling thickness were settled on both ends of the substrate. Thereafter, the coated composition was covered with another glass substrate, and then hardened at 90° C. for 30 minutes, thereby producing a 20 μm thick transparent protective layer. The ionic conductivity of the protection layer was measured and found to be 1.5×10⁻⁴ S/cm. The obtained protective layer was transparent and exhibited good adhesion and ductility, but slightly weak mechanical strength.

### EXAMPLES 5 TO 24

5.8 g of a multifunctional monomer, 5.8 g of a reactive monomer, 8.4 g of a plasticizer, 3.65 g of a LiN(CF₃SO₂)₂ lithium salt, and 0.083 g of a benzoinethylether photoinitiator were mixed to completely dissolve the lithium salt and the photoinitiator, thereby obtaining a composition for protecting a negative electrode. The multifunctional monomers, reactive monomers, and plasticizers used in these examples are shown in Table 1. Using the various compositions protective layers were produced according to the same procedure as in Example 1, and their ionic conductivity was measured. The results are presented in Table 1.

TABLE 1

| | Reactive | Multifunctional | | Ionic conductivity |
|---|---|---|---|---|
| | monomer | monomer | Plasticizer | (S/cm) |
| Example 5 | EGDMA | PEGMEMA 300 | PEGDME | 4.54 × 10⁻⁵ |
| Example 6 | TriEGDMA | PEGMEMA 300 | Triglyme | 4.55 × 10⁻⁴ |
| Example 7 | Tetegdma | PEGEEMA 246 | Triglyme | 3.97 × 10⁻⁴ |
| Example 8 | PEDGA 258 | DEGMEMA | tetraglyme | 3.28 × 10⁻⁴ |
| Example 9 | PEGDMA 330 | DEGMEMA | PEGDME 250 | 2.55 × 10⁻⁴ |
| Example 10 | PEGDMA 330 | PEGEEMA 246 | PEGDME 250 | 4.02 × 10⁻⁴ |
| Example 11 | EGDMA | EGMEA | DME | 1.15 × 10⁻⁴ |
| Example 12 | DEGDMA | DEGMEMA | DGM | 2.03 × 10⁻⁴ |
| Example 13 | TriEGDMA | PEGEEMA 246 | TriGM | 2.17 × 10⁻⁴ |
| Example 14 | TetEGDA | PEGMEMA 300 | TetGM | 2.52 × 10⁻⁴ |
| Example 15 | PEGDA 258 | PEGMEMA 475 | PEGDME 250 | 3.54 × 10⁻⁴ |
| Example 16 | PEGDMA 330 | PEGMEMA 1100 | PEGDME 500 | 7.34 × 10⁻⁵ |
| Example 17 | PEGDMA 1100 | PEGMEMA 2080 | PEGDME 500 | 3.75 × 10⁻⁵ |
| Example 18 | PEGDA 540 | PPGMEA 202 | PEGDME 250 | 8.63 × 10⁻⁵ |
| Example 19 | EGDMA | PPGMEA 202 | TetGM | 7.49 × 10⁻⁵ |
| Example 20 | DEGDMA | PEGMEMA 2080 | TriGM | 5.28 × 10⁻⁴ |
| Example 21 | TriEGDMA | PEGMEMA 1100 | DGM | 1.75 × 10⁻⁴ |
| Example 22 | TetEGDMA | PEGMEMA 475 | DME | 5.24 × 10⁻⁴ |
| Example 23 | PEGDA | PEGMEMA 300 | TetGM | 4.52 × 10⁻⁴ |
| Example 24 | PEGDMA 1100 | DEGMEMA | TetGM | 1.53 × 10⁻⁴ |
| Example 25 | PPGDA 540 | EGMEA | PEGDME 250 | 6.84 × 10⁻⁵ |

The protective layers prepared layers according to Examples 4 to 24 were transparent and exhibited good adhesion, ductility, and mechanical strength.

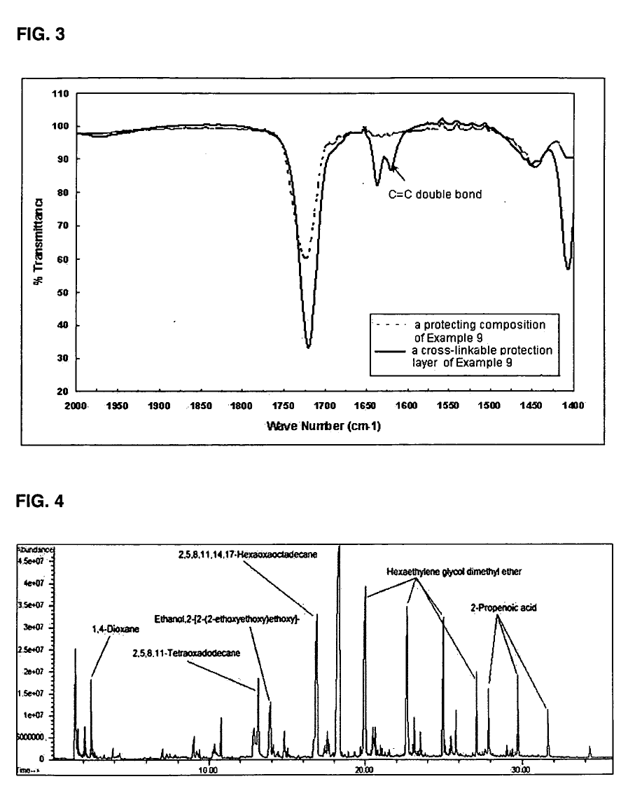

To confirm that a cross-linking reaction had taken place, the composition according to Example 9 was analyzed by FT-IR. The results are presented in FIG. 3, where it is seen that the peak that corresponds to the composition's double bond (at 1,650 to 1,600 cm⁻¹) disappeared after UV irradiation. This result indicated that the composition was cross-linked. In addition, the cross-linked protective layer was analyzed by pyrolysis-gas chromatography. The results are presented in FIG. 4. The identified materials correspond to the prolysis products expected for a crosslinked material of this type.

### EXAMPLE 26

5.5 g of a polyethylene glycol dimethacrylate (molecular weight 1,100) multifunctional monomer, 5.5 g of a polyethylene glycol methylether methacrylate (molecular weight 475) reactive monomer, 9.0 g of a dimethoxyethane plasiticizer, 3.25 g of a LiN(CF₃SO₂)₂ lithium salt, and 0.078 g of a benzoinethyl ether photoinitiator were mixed to completely dissolve the lithium salt and the photoinitiator, thereby obtaining a composition for protecting a negative electrode. Using the composition, a cross-linked protective layer was produced according to the same procedure as in Example 1 and its ionic conductivity was measured. The measured ionic conductivity was 2.3×10⁻³ S/cm. The obtained protective layer was transparent and exhibited good adhesion and ductility and suitable mechanical strength.

### EXAMPLE 27

The composition according to Example 26 was coated on 50 μm thick lithium metal and hardened to produce a negative electrode coated with the protective layer.

An elemental sulfur (S₈) positive active material, a Super-P conductive agent, and a polyethylene oxide (molecular weight 5,000,000) binder were dissolved in an acetonitrile organic solvent in the weight ratio of 60:20:20 to prepare a positive active material slurry. Using the positive active material slurry, a positive electrode was produced.

Using the negative electrode, the positive electrode, and an electrolyte, a lithium metal sulfur battery was fabricated. As the electrolyte, 1M LiCF₃SO₃ in a mixed solvent of dioxolane, dimethoxyethane, bis(2-methoxyethylether), and sulforane (5:2:2:1 volume ratio) was used.

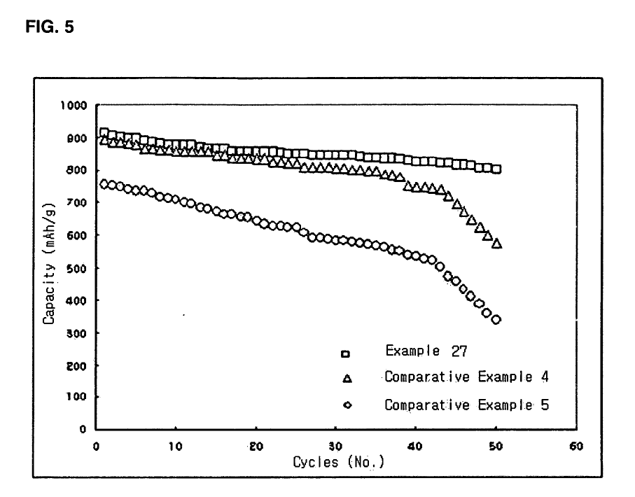

The lithium metal sulfur battery was charged at 0.5 C, and its capacity and the cycle life characteristics were measured. The results are presented in FIG. 5.

### EXAMPLE 28

10 g of a polyethylene glycol diacrylate multifunctional monomer, 10 g of a polyethylene glycol dimethylether (molecular weight 250), 2.0 g of a LiCF₃SO₃ lithium salt, and 0.047 g of a benzoinethylether photoinitiator were mixed to completely dissolve the lithium salt and the photoinitiator, thereby obtaining a composition for protecting a negative electrode.

Using the composition, a cross-linked protective layer was formed according to the same procedure as in Example 1, and its ionic conductivity was measured. The ionic conductivity was 3.0×10⁻⁶ S/cm. The obtained protective layer was slightly hard and had a surface at which polyethylene glycol dimethylether was present in a large amount.

### COMPARATIVE EXAMPLE 1

10 g of a polyethylene glycol diacrylate multifunctional monomer, 10 g of a polyethylene glycol methylether methacrylate (molecular weight 330), 2.0 g of a LiCF₃SO₃ lithium salt and 0.047 g of a benzoinethylether photoinitiator were mixed to completely dissolve the lithium salt and the photoinitiator, thereby obtaining a composition for protecting a negative electrode. Using the composition, a cross-linked protective layer was formed according to the same procedure as in Example 1, and its ionic conductivity was measured. The ionic conductivity was 1.4×10⁻⁷ S/cm. The protective layer was slightly hard and exhibited good adhesion.

### COMPARATIVE EXAMPLE 2

10 g of a polyethylene glycol methylether methacrylate (molecular weight 330) reactive monomer, 10 g of a polyethylene glycol dimethylether (molecular weight 250) plasticizer, 2.0 g of a LiCF₃SO₃ lithium salt, and 0.047 g of a benzoinethylether photoinitiator were mixed to completely dissolve them, thereby obtaining a composition for protecting a negative electrode. An attempt was made to cure the composition, but the composition did not harden, and a protective layer could not be formed.

### COMPARATIVE EXAMPLE 3

A lithium metal sulfur battery was fabricated by the same procedure as in Example 2, except that 50 μm thick lithium metal was used as a negative electrode. The lithium metal sulfur battery was charged and its capacity and cycle life characteristics were measured. The results are presented in FIG. 5.

### COMPARATIVE EXAMPLE 4

A lithium metal sulfur battery was fabricated by the same procedure as in Example 27, except a propylene carbonate plasticizer was used instead of dimethoxyethane as in the composition according to Examples 26. The lithium metal sulfur battery was charged at 0.5 C and its capacity and cycle life characteristics were measured. The results are presented in FIG. 5.

As shown in FIG. 5, the cell with the protective layer prepared according to Example 27 exhibited good initial capacity and good cycle life. The cell without the protective layer prepared according to Comparative Example 3 exhibited a capacity comparable to that of the cell prepared according to Example 27 up to 40th cycles, but thereafter a substantially lower capacity. Furthermore, the cell using a propylene carbonate plasticizer prepared according to Comparative Example 4 exhibited a much lower initial capacity and cycle life than the cell prepared according to Example 27.

As described above, the composition of the present invention is formed on a negative electrode, resulting in reduced reactivity of the negative electrode and stabilization of the surface of the negative electrode, thereby improving battery cycle life.

While the present invention has been described in detail with reference to the preferred embodiments, those skilled in the art will appreciate that various modifications and substitutions can be made thereto without departing from the spirit and scope of the present invention as set forth in the appended claims.

1. A composition for protecting a negative electrode for a lithium metal battery, comprising:
a multifunctional monomer having at least two double bonds for facilitating cross-linking;
a plasticizer having an ether group; and
at least one alkali metal salt.

2. The composition of claim 1, wherein the multifunctional group has a number average molecular weight of from 170 to 4,000.

3. The composition of claim 1, wherein the multifunctional group comprises (a) an allyl group-included compound selected from the group consisting of diallyl maleate, diallyl sebacate, diallyl phthalate, trially cyanurate, trially isocyanurate, trially trimellitate, and triallyl trimesate; (b) an acrylate-based compound selected from the group consisting of ethylene glycol di(meth)acrylate(EGD(M)A), diethylene glycol di(meth)acrylate([DEGD(M)A], triethylene glycol di(meth)acrylate (TriEGD(M)A), tetraethylene glycol di(meth)acrylate(TetEGD(M)A), polyethylene glycol di(meth) acrylate (PEGD(M)A), tripropylene glycol di(meth) acrylate (TriPGD(M)A), tetrapropylene glycol di(meth)acrylate (TetPGD(M)A), nonapropylene glycol di(meth)acrylate (NPGD(M)A), polypropylene glycol di(meth)acrylate (PPGD(M)A), 1,3-butylene glycol di(meth)acrylate, 1,4-butanediol di(meth)acrylate, 1,5-pentadiol di(meth)acrylate, neopentyl glycol di(meth)acrylate, diacrylate of caprolactonemodified neopentyl glycol hydroxypivalate ester, 1,6-hexanediol di(meth)acrylate, 1,6-hexanediol ethoxylate di(meth)acrylate, 1,6-hexanediol propylate di(meth)acrylate, trimethylolpropane tri(meth)acrylate, trimethylolpropane ethoxylate tri(meth)acrylate, trimethylolpropane benzoate di(meth)acrylate, propylene oxide-modified trimethylol propane tri(meth)acrylate, di(trimethylolpropane) tetra(meth)acrylate, pentaerythritol tri(meth)acrylate, pentaerythritol tetra(meth)acrylate, pentaerythritol propylate tri(meth)acrylate, dipentaerythritol penta-/hexa(meth)acrylate, alkyloyl-partially-modified dipentaerythritol acrylate, hexa(meth)acrylate of dipentaerythritol-partially-modified caprolactone, bisphenol A di(meth)acrylate, bisphenol A ethoxylate di(meth)acrylate, diacrylate of bisphenol F partially-modified ethylene oxide, 3-hydroxy-2,2-dimethylpropyl-3-hydroxy-2,2-dimethylpropionate di(meth)acrylate, 1,14-tetradecanediol di(meth)acrylate, tricycle(5.2.1.0(2,6))decanedimethanol di(meth)acrylate, and S,S′-thiodi-4,1-phenylene bis(thiomethacrylate); or (c) an acryloyl-based compound selected from the group consisting of poly(acrylonitrile-co-butadiene-co-acrylic acid), dicarboxy-terminated, glycidyl methacrylate diester; bis(2-(methacryloyloxy)ethyl phosphate; trismethacryloyloxyethyl phosphate; bismethacryloyloxyethyl hydroxyethyl isocyanu rate; tri(2-acryloyloxy)ethyl isocyanurate; trismethacryloyloxyethyl isocyanurate; hydroxypivayl hydroxylpivalate bis(6-(acryloyloxy)hexanoate); and 1,3,5-triacryloylhexahydroxy-1,3,5-triazine.

4. The composition of claim 1, wherein an amount of the multifunctional monomer is present in an amount of from 5 to 50 parts by weight, based on 100 parts by weight of the total composition.

5. The composition of claim 4, wherein an amount of the multifunctional monomer is present in an amount of from 10 to 35 parts by weight, based on 100 parts by weight of the total composition.

6. The composition of claim 1, wherein the composition further comprises a reactive monomer having an alkylene oxide group and a reactive double bond.

7. The composition of claim 6, wherein the reactive monomer is represented by formula 1: 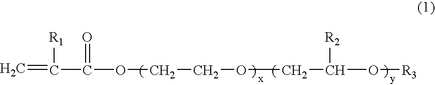
where, R₁ and R₂ are the same or independently selected from H or a C₁ to C₆ alkyl; R₃ is H, a C₁ to C₁₂ alkyl, or a C₆ to C₃₆ aryl; R₁ to R₃ are all the same or all different; one of R₁ to R₃ is different from the remaining two of R₁ to R₃; and
x≧1,y≧0, or x≧0, y≧1.

8. The composition of claim 6, wherein the reactive monomer has a number average molecular weight of 130 to 1,100.

9. The composition of claim 6, wherein the reactive monomer is at least one selected from the group consisting of ethylene glycol methyl ether (meth)acrylate (EGME(M)A), ethylene glycol phenylether (meth)acrylate (EGPE(M)A), ethylene glycol phenylether (meth)acrylate (EGPE(M)A), diethylene glycol methyl ether (meth)acrylate (DEGME(M)A), diethylene glycol 2-ethylhexylether (meth)acrylate (DEGEHE(M)A), polyethylene glycol methyl ether (meth)acrylate (PEGME(M)A), polyethylene glycol ethylether (meth)acrylate (PEGEE(M)A), polyethylene glycol 4-nonylphenylether (meth) acrylate (PEGNPE(M)A), polyethylene glycol phenylether (meth)acrylate (PEGPE(M)A), ethylene glycol dicyclophenylether (meth)acrylate (EGDCPE(M)A), polypropylene glycol methylether (meth)acrylate (PPGME(M)A), polypropylene glycol 4-nonylphenylether(meth) acrylate, and dipropylene glycol allylether (meth) acrylate.

10. The composition of claim 6, wherein the reactive monomer is present in an amount at from 5 to 90 parts by weight, based on 100 parts by weight of the total composition.

11. The composition of claim 10, wherein an amount of the reactive monomer is present in an amount of from 15 to 50 parts by weight, based on 100 parts by weight of the total composition.

12. The composition of claim 1, wherein the plasticizer is a C₄ to C₃₀ alkylene glycol dialkyl ether or a C₃ to C₄ cyclic ether.

13. The composition of claim 1, wherein the plasticizer comprises at least one plasticizer selected from the group consisting of dimethoxy ethane (DME), bis(2-methoxyethylether) (DGM), triethylene glycol dimethylether (TriGM), tetraethylene glycol dimethylether (TetGM), polyethylene glycol dimethylether (PEGDME), propylene glycol dimethylether, and dioxolane.

14. The composition of claim 1, wherein the plasticizer is present in an amount of from 5 to 70 parts by weight, based on 100 parts by weight of the total composition.

15. The composition of claim 14, wherein the plasticizer is present in an amount of from 20 to 50 parts by weight, based on 100 parts by weight of the total composition.

16. The composition of claim 1, wherein the alkali metal salt is represented by formula 2:
AB (2)
where, A is a cation of an alkali metal selected from the group consisting of lithium, sodium, and potassium; and
B is an anion.

17. The composition of claim 1, wherein the alkali metal salt is at least one compound selected from the group consisting of LiClO₄, LiBF₄, LiPF₆, LiAsF₆, LiAlCl₄, LiSbF₆, LiSCN, LiCF₃SO₃, LiN(CF₃SO₂)₂, LiN(C₂F₅SO₂)₂, LiC₄F₉SO₃, LiCF₃CO₂, LiN(CF₃CO₂)₃, NaClO₄, NaBF₄, NaSCN, and KBF₄.

18. The composition of claim 1, wherein the alkali metal salt is present in an amount of from 3 to 20 parts by weight, based on 100 parts by weight of the total composition.

19. The composition of claim 18, wherein an amount of the alkali metal salt is present in an amount of from 5 to 20 parts by weight, based on 100 parts by weight of the total composition.

20. The composition of claim 1, wherein the composition further comprises a photoinitiator or a thermal initiator.

21. The composition of claim 20, wherein the photoinitiator is selected from the group consisting of benzoin, benzoinethylether, benzoinisobutylether, alphamethylbenzoinethylether, benzoin phenylether, acetophenone, dimethoxyphenylacetophenone, 2,2-diethoxyacetophenone, 1,1-dichloroacetophenone, trichloroacetophenone, benzophenone, p-chlorobenzophenone, 2,4-dihydroxybenzophenone, 2-hydroxy-4-methoxybenzopheneon, 2-hydroxy-2-methyl propionphenone, benzyl benzoate, benzoyl benzoate, anthraquinone, 2-ethylanthraquinone, 2-chloroanthraquinone, 2-methyl-1-(4-methylthiophenyl)-morpolynopropaneone-1,2-hydroxy-2-methyl-1-phenylpropane-1-one, 2-benzyl-2-dimethylamino-1-(4-morpolynophenyl)-butanone-1, 1-hydroxycyclohexylphenylketone, benzyldimethylketal, thioxanthone, isopropyl thioxanthone, chlorothioxanthone, benzyl disulfide, butanedione, carbazole, fluorenone, and alphaacyloxime ester; and
the thermal initiator is selected from the group consisting of benzoyl peroxide, acetyl peroxide, dilauryl peroxide, di-tert-butyl peroxide, cumyl hydroperoxide, azobisbutyronitrile, and azobisisovaleronitrile.

22. The composition of claim 20, wherein an amount of the photo initiator or the thermal initiator is present in an amount of from 0.1 to 1 part by weight, based on 100 parts by weight of the total composition.

23. A composition for protecting a negative electrode for a lithium metal battery, comprising:
a multifunctional monomer having at least two double bonds for facilitating cross-linking;
a reactive monomer having an alkylene oxide group and a reactive double bond;
a plasticizer having an ether group; and
at least one alkali metal salt.

24. A lithium metal battery comprising:
a positive electrode comprising a positive active material;
a negative electrode comprising a negative active material selected from lithium metal or an alloy of lithium metal, wherein the negative electrode has a protective layer formed by curing a composition comprising a multifunctional monomer having at least two double bonds for facilitating of cross-linking, a plasticizer having an ether group, and at least one alkali metal salt.

25. The lithium metal battery of claim 24, wherein the protective layer further comprises a reactive monomer having an alkylene oxide group and a reactive double bond.

26. The lithium metal battery of claim 24, wherein the protective layer has a thickness of 0.1 to 50 μm.

27. The lithium metal battery of claim 26, wherein the protective layer has a thickness of 0.3 to 30 μm.

28. The lithium metal battery of claim 24, wherein the negative electrode further comprises an inorganic protective layer selected from an inorganic single layer and an inorganic double layer.

29. The lithium metal battery of claim 28, wherein the inorganic protective layer is selected from the group consisting of LiPON, Li₂CO₃, Li₃N, Li₃PO₄, and Li₅PO₄.

30. The lithium metal battery of claim 28, wherein the inorganic protective layer is selected from the group consisting of lithium nitride, lithium carbonate, lithium silicate, lithium borate, lithium aluminate, lithium phosphate, lithium phosphorous oxynitride, lithium silicosulfide, lithium germanosulfide, lithium lanthanum oxide, lithium titanium oxide, lithium borosulfide, lithium aluminosulfide, lithium phosphosulfide, and mixtures thereof.

31. The lithium metal battery of claim 28, wherein the inorganic protective layer has a thickness of 10 Å to 10,000 Å.

32. The lithium metal battery of claim 24, wherein the positive active material is selected from the group consisting of elemental sulfur (S₈), Li₂Sₙ (n≧1), Li₂Sₙ (n≧1) dissolved in catholyte, an organic sulfur compound, and a carbon-sulfur polymer [(C₂Sₓ)ₙ, x=2.5-50, n≧2].

33. The lithium metal battery of claim 24, wherein the positive active material is a lithium transition metal oxide.
